(19) United States
(12) Patent Application Publication
(10) Pub. No.: US 2024/0303466 A1
(43) Pub. Date: Sep. 12, 2024

(54) OPTIMIZATION FOR CASCADE MACHINE LEARNING MODELS

(71) Applicant: PAYPAL, INC., San Jose, CA (US)

(72) Inventors: Nitin Satyanarayan Sharma, San Francisco, CA (US); Sanae Amani Geshnigani, San Jose, CA (US)

(21) Appl. No.: 18/182,191

(22) Filed: Mar. 10, 2023

(51) Int. Cl. G06N 3/045; G06N 3/08

(52) U.S. Cl. CPC G06N 3/045; G06N 3/08; G06Q 20/4016

(57) ABSTRACT

Methods and systems are presented for improving the accuracy performance and utilization rates of a cascade machine learning model system. The cascade machine learning model system includes multiple machine learning models configured to process transactions according to a cascade operation scheme. Hyperparameter values usable to configure the multiple machine learning models are determined collectively such that the hyperparameter values are selected to optimize the performance of the multiple machine learning models when the models operate according to the cascade operation scheme. Furthermore, an efficacy determination model is used to determine an efficacy of the cascade machine learning model in processing a given transaction. Based on an output of the efficacy determination model, one or more characteristics of the cascade machine learning model are modified for processing the transaction.

### BACKGROUND

The present specification generally relates to machine learning models, and more specifically, to a framework for configuring, training, and utilizing a cascade machine learning model system according to various embodiments of the disclosure.

### RELATED ART

Machine learning models have been widely used to perform various tasks for different reasons. For example, machine learning models may be used in classifying data (e.g., determining whether a transaction is a legitimate transaction or a fraudulent transaction, determining whether a merchant is a high-value merchant or not, determining whether a user is a high-risk user or not, etc.). Many machine learning models are utilized in real-time (e.g., as transactions are being processed, as a request is submitted by a user, etc.) such that services can be provided to users without substantial delay. Furthermore, due to their effectiveness in making predictions (e.g., performing data classification, etc.), an increasing number of machine learning models are deployed to perform tasks with a higher complexity.

However, as the tasks (e.g., data classification) become more complex, longer times are required by the machine learning models to perform the tasks accurately. It would be advantageous for a machine learning model framework to balance and/or optimize accuracy and speed of a machine learning model to perform complex tasks.

### BRIEF DESCRIPTION OF THE FIGURES

FIG. 1 is a block diagram illustrating an electronic transaction system according to an embodiment of the present disclosure;

FIG. 2 is a block diagram illustrating a cascade machine learning model system according to an embodiment of the present disclosure;

FIG. 3A illustrates an example efficacy determination model for evaluating an efficacy of a cascade machine learning model system in processing a transaction according to an embodiment of the present disclosure;

FIG. 3B illustrates various accuracy categories associated with a cascade machine learning model system according to an embodiment of the present disclosure;

FIG. 4 is a block diagram illustrating another cascade machine learning model system according to an embodiment of the present disclosure;

FIG. 5 is a flowchart showing a process of selecting hyperparameters for a cascade machine learning model system according to an embodiment of the present disclosure;

FIG. 6 is a flowchart showing a process of incorporating an efficacy determination model into a framework for utilizing a cascade a machine learning model system according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for improving accuracy and utilization rates of a cascade machine learning model system. As discussed above, many machine learning models have been deployed to perform complex tasks in real-time. For example, a machine learning model may be configured to classify a transaction (e.g., determining whether the transaction is a fraudulent transaction or not) as a transaction request is received, such that an organization (or another computer module) may determine how to process the transaction based on the classification in real-time.

As the task and the machine learning model configured to perform the task become increasingly complex (e.g., the number of input features for the machine learning model is above a threshold, the number of connections within a neural network is above a threshold, the amount of data needed to be considered for performing the task, etc.), the amount of time required by the machine learning model to perform the task (e.g., to classify transactions) may increase as well. Since the machine learning model is deployed to perform the task in real-time, the increased amount of time required to perform the task may cause delay or even disruption to providing services to users.

One solution to reduce or eliminate the delay and/or disruption of services is to adopt a cascade (e.g., tiered) machine learning model system that utilizes two or more machine learning models to perform the task in a cascade manner (e.g., according to a cascade operation scheme). In some embodiments, the cascade machine learning model system may include at least a first machine learning model and a second machine learning model, where the first machine learning model is configured to perform the task in less time than the second machine learning model. For example, if both the first machine learning model and the second machine learning model are implemented using the same type of machine learning model (e.g., an artificial neural network, a gradient boosting tree, a decision tree, a transformer, etc.), the second machine learning model may be implemented with more complexity than the first machine learning model (e.g., configured to receive and analyze more input features to perform the task, include more analyses and/or decision points, more internal layers and/or connections, etc.). In another example, the first machine learning model may be implemented using a simpler machine learning model architecture (e.g., a decision tree, etc.) while the second machine learning model may be implemented using a more complex machine learning model architecture (e.g., an artificial neural network, an ensemble of multiple models, a gradient boosting tree, etc.).

Since the first machine learning model is less complex (e.g., may consider a smaller number of features when performing the task, perform a smaller number of analyses or less sophisticated analyses when performing the task, etc.), the first machine learning model may perform the task faster than the second machine learning model, while having less capability in performing the task (e.g., having less accuracy in predictions, etc.) than the second machine learning model. In some embodiments, in order to maximize the limited capability of the first machine learning model, the cascade machine learning model system may configure and/or train the first machine learning model to focus on a first portion of the task, but not the entire task. For example, when the cascade machine learning model system is configured to classify data into one of multiple classifications, the cascade machine learning model system may configure the first machine learning model to have a bias in one of the classifications (e.g., a first classification), such that the first machine learning model may be configured to have an acceptable accuracy (e.g., a prediction accuracy above a predetermined threshold) for the first classification, but not the remaining classification(s) (e.g., a second classification). In an example where the cascade machine learning model system is configured to classify transactions as either fraudulent transactions or non-fraudulent transactions, the first machine learning model may be configured and trained to classify transactions as non-fraudulent transactions with an acceptable accuracy (e.g., a false-positive below a threshold such as 5%, 1%, 0.5%, etc.).

By focusing the first machine learning model on the first portion of the task (e.g., the first classification), the cascade machine learning model system may utilize the first and second machine learning models to perform the task in a cascade manner (e.g., according to a cascade operation scheme). Specifically, according to the cascade operation scheme, when a request (e.g., a classification request) is received, data associated with the request is first provided to a first machine learning model of the cascade machine learning model system. If the first machine learning model classifies the data as the first classification (e.g., classifying a transaction as a non-fraudulent transaction), due to the acceptable performance of the first machine learning model in classifying data as the first classification, the cascade machine learning model system may bypass the second machine learning model, and use the classification prediction provided by the first machine learning model as an output of the cascade machine learning model system. This way, for requests that are classified as the first classification by the first machine learning model, the processing time can be drastically improved (e.g., reduced) without sacrificing any accuracy performance.

On the other hand, if the first machine learning model classifies the data as any classification other than the first classification (e.g., classifying the transaction as a fraudulent transaction), due to the fact that the prediction performance of the first machine learning model in classifying data as a classification other than the first classification may not be acceptable, the cascade machine learning model system may subsequently provide the data to the second machine learning model to perform the task (e.g., to re-classify the transaction). Since the second machine learning model includes a more complex architecture, the second machine learning model may take a longer time than the first machine learning model to perform the task, but may perform other portions of the task (e.g., a second portion) with an acceptable accuracy (e.g., having a prediction accuracy above a threshold, having a false-positive and/or a false negative rate below a threshold, etc.). Note that the desired accuracy for the first and second machine learning models may vary based on the classification and consequences of wrongly classifying a task or request. For example, an entity may require much more accuracy is classifying a transaction as non-fraudulent, as misclassifying a fraudulent transaction as non-fraudulent could lead to large monetary losses. On the other hand, a lower accuracy for mis-classifying a non-fraudulent transaction as fraudulent may be acceptable, as such a misclassification may simply require additional data from the user to then approve the transaction. As such, the output of the first machine learning model may be used if the transaction is classified as fraudulent, but the output of the second machine learning model is used if the transaction is classified as non-fraudulent by the first machine learning model.

In this example, the cascade machine learning model system includes only two machine learning model that operate in a cascade manner. However, in other embodiments, the cascade machine learning model system may include more than two machine learning models, such that a third model, a fourth model, a fifth model, etc. These additional models may be added to the cascade machine learning model system in different ways according to different cascade operation schemes, which will be discussed in more detail below.

While using such a cascade structure may improve the speed performance of the cascade machine learning model system in performing the task, the performance and utilization rate for the cascade machine learning model system can still be further improved. Since the different machine learning models included in the cascade machine learning model system (e.g., the first machine learning model and the second machine learning model) are separate models that are not linked to each other or even share any internal structure with each other, the different machine learning models are typically configured and trained independently from each other. For example, the first machine learning model may be configured and trained with a first set of hyperparameters. Hyperparameters in a machine learning model are parameters that control the learning process of the machine learning model, such as a learning rate, a solver, a regularization constant, an activation value, a selection of an optimization algorithm, a train-test split ratio, a selection of a loss function, a number of hidden layers if the model is a neural network, a dropout rate in neural network, etc. These hyperparameters are determined prior to the training process and control how the training process is conducted, which in turn may affect how the machine learning model will turn out. The first set of hyperparameters may be determined to optimize the performance of the first machine learning model as if the first machine learning model is being utilized as a stand-alone model (e.g., in silo).

Similarly, the second machine learning model may be configured and trained with a second set of hyperparameters. The second set of hyperparameters may be determined to optimize the performance of the second machine learning model as if the second machine learning model is being utilized as a stand-alone model (e.g., in silo). While such a way of determining the hyperparameters may optimize the performance of the different models when they are operated independently, those hyperparameters may not be selected to optimize the performance of the different models when they are operated together (e.g., in a cascade manner) within the cascade machine learning model system.

Furthermore, the rigid structure of the cascade machine learning model system (e.g., how each request is required to be processed by the first machine learning model and then processed by the second machine learning model according to the cascade operation scheme, etc.) may reduce the utilization rate of the cascade machine learning model system. For example, due to such a rigid structure, requests that can likely be classified correctly by the first machine learning model (or the second machine learning model) may be forced to go through the different models according to the cascade operation scheme, where resources (e.g., time and/or computer resources) may be wasted. In another example, due to one or more anomalies, a human administrator (or another computer module) may overgeneralize certain prediction patterns and may determine that the cascade machine learning model system cannot accurately classifying a certain group of data (e.g., transactions that are originated from a particular country, etc.), such that any data that is part of the group (e.g., any transactions that are originated from the particular country) may be excluded from using the cascade machine learning model system, which may unnecessarily reduce the utilization rate of the cascade machine learning model system.

Thus, according to various embodiments of the disclosure, a transaction processing system may configure, train, and utilize a cascade machine learning model system in a manner that improves the overall accuracy and the utilization rate of the cascade machine learning model system. As discussed herein, a conventional cascade machine learning model system may configure and train each machine learning model within the system independently. Configuring and training a machine learning model this way may optimize the performance of the model when it is operated as a stand-alone model, but may not optimize the performance of the model when it is operated in concert with the other machine learning models in the cascade machine learning model system.

As such, in order to improve the overall accuracy performance of the cascade machine learning model system, the transaction processing system may configure and train the different machine learning models within the cascade machine learning model system collectively such that the overall performance of the cascade machine learning model system (when the different machine learning models are operated together according to a cascade operation scheme of the cascade machine learning model system) can be optimized. In some embodiments, the transaction processing system may determine hyperparameters for each of the machine learning models within the cascade machine learning model system, and may determine hyperparameter values for all of the different machine learning models collectively to optimize the performance of the cascade machine learning model system. Since the cascade machine learning model system may include machine learning models of different types (e.g., decision trees, gradient boosting trees, transformers, artificial neural networks, etc.), each of the machine learning models within the cascade machine learning model system may be associated with different hyperparameters. Thus, the transaction processing system may first determine hyperparameters associated with each of the machine learning models within the cascade machine learning model system, and the possible hyperparameter values (e.g., a range, a discrete set of possible values, etc.) for each of the hyperparameters. For example, if the cascade machine learning model system includes a first machine learning model associated with a first set of hyperparameters and a second machine learning model associated with a second set of hyperparameters, the transaction processing models may determine the set of joint hyperparameters for the cascade machine learning model system by combining the first set of hyperparameters with the second set of hyperparameters.

The transaction processing system may then determine a set of possible joint hyperparameter configurations for all of the machine learning models in the cascade machine learning model system. Each joint hyperparameter configuration may include hyperparameter values for all of the hyperparameters of the different machine learning models in the cascade machine learning model system, and may have at least one different hyperparameter value from other joint hyperparameter configurations. For example, the transaction processing system may generate a first joint hyperparameter configuration using an initial set of hyperparameter values for the first set of hyperparameters and the second set of hyperparameters. The transaction processing system may then generate other joint hyperparameter configurations by modifying one or more of the hyperparameter values. If a hyperparameter is associated with a set of discrete values, the transaction processing system may generate a new joint hyperparameter configuration by changing the hyperparameter value to a different discrete value for the hyperparameter. In the case where the hyperparameter is associated with a range of values, the transaction processing system may first determine a set of discrete values (based on a predetermined limit of the number of different discrete values, as the number of different discrete values can be infinite within the range) within the range for use in determining the various joint hyperparameter configurations, and then select different values for that hyperparameter in different joint hyperparameter configurations.

The transaction processing system may generate different instances of the cascade machine learning model system using the set of possible joint hyperparameter configurations, where each instance of the cascade machine learning model system is generated by configuring and training the different machine learning models within the system together using a distinct joint hyperparameter configuration. The transaction processing system may then evaluate the accuracy performance of the different instances of the cascade machine learning model system using a validation data set (which may be the same or different from the training data set used to train the different instances of the cascade machine learning model system). The transaction processing module may identify a particular instance of the cascade machine learning model system that has the highest accuracy performance, and determine to deploy the particular instance of the cascade machine learning model system for use in a live environment.

However, when the number of possible joint hyperparameter configurations is large (e.g., above a threshold number), for example, due to a large number of hyperparameters associated with the different machine learning models, the time and the computer resources required to configure, train, and evaluate the different instances of the cascade machine learning model system may be excessive (e.g., exceeding a time and/or computer resource constraint). In order to reduce the amount of time and computer resources (or to limit the time and computer resources within the constraint) for selecting an optimal joint hyperparameter configuration for the cascade machine learning model system, the transaction processing system of some embodiments may adopt a successive halving technique in configuring, training, and evaluating the different instances of the cascade machine learning model system.

Using the successive halving technique, the transaction processing system may perform the training and evaluating of the instances of the cascade machine learning model system in multiple iterations. In each iteration, the transaction processing system may remove half of the instances of the cascade machine learning model system that have lower accuracy performance than the remaining half of the instances of the cascade machine learning model system. The transaction processing system may iteratively train instances of the cascade machine learning model system and then remove half of the instances of the cascade machine learning model system until only one instance of the cascade machine learning model system remains. In some embodiments, the transaction processing system may use only a portion of the available training data to train the instances of the cascade machine learning model system and use only a portion of the available validation data to evaluate the instances of the cascade machine learning model system in each iteration, such that the instances of the cascade machine learning model system may continuously be trained using a different portion of the available training data in each iteration.

For example, if one hundred sets of training data set are available and the instances of the cascade machine learning model system will be evaluated in five iterations, the transaction processing system may divide the hundred sets of training data into five portions of different training data. When the training data is divided evenly, each portion may include twenty sets of training data (however, the training data can be divided in other ways in different embodiments). In the first iteration, the transaction processing system may use the first portion of the training data to train the different instances of the cascade machine learning model system based on the different joint hyperparameter configurations. The transaction processing system may evaluate the instances of the cascade machine learning model system using a portion of the validation data, and remove half of the instances of the cascade machine learning model system. It is noted that the evaluation is performed on different instances of the entire cascade machine learning model system, that is, the evaluation is on the collective output produced by the different machine learning models within the cascade machine learning model system working together. The transaction processing system may assess the performance of the cascade machine learning model system under different configurations as a whole, rather than evaluating the machine learning models individually.

While using only a portion (e.g., less than half) of the training data to train the instances of the cascade machine learning model system may limit the way that the different machine learning models in the cascade machine learning model system perform (and be evaluated), it should be sufficient for the transaction processing system to identify the worst half of the different instances of the cascade machine learning model system and remove those worst performers.

After removing the worst performers, the transaction processing system may then train the remaining half of the instances of the cascade machine learning model system using a second portion of the training data. Since that remaining half of the instances of the cascade machine learning model system has already been trained using the first portion of the training data, the training during the second iteration is added on (e.g., successive) to the remaining half of the instances of the cascade machine learning model system. While the instances of the cascade machine learning model system may only be trained using a small portion of the available training data during the first iteration, as the transaction processing system continues to train and evaluate the different instances of the cascade machine learning model system, the remaining instances of the cascade machine learning model system are receiving more and more training. Thus, as the evaluation of the instances of the cascade machine learning model system becomes more crucial (when the remaining number of instances of the cascade machine learning model system is small, such as below a threshold), the instances of the cascade machine learning model have been trained with a larger amount of training data, which enables the transaction processing system to be more accurately identify good performers from bad performers.

By using the successive halving technique, the majority of the instances of the cascade machine learning model system (especially the bad performers that are removed in the earlier iterations) is trained using only a small portion of the available training data, which significantly reduces the time and computer resources required to evaluate those instances of the cascade machine learning model system. However, the good performers (the instances of the cascade machine learning model system that remain during the last few iterations) are trained using a larger portion of the available training data (or even the entire available training data), which enables the transaction processing system to more accurately and precisely evaluate the instances of the cascade machine learning model system and identify the optimal instance of the cascade machine learning model system for deployment. Since the instance of the cascade machine learning model system (and its associated joint hyperparameter configuration) is selected based on the collective performance of the different models working together in the cascade machine learning model system, the joint hyperparameter configuration selected for the cascade machine learning model system provides optimal accuracy performance for the cascade machine learning model system as a whole.

According to some embodiments of the disclosure, the transaction processing system may also provide a framework that improves the utilization rate of the cascade machine learning model system. As discussed herein, the rigid structure of the cascade machine learning model system that follows a particular cascade operation scheme may prevent the cascade machine learning model system from being utilized efficiently in some cases. For example, since each request has to follow the cascade operation scheme (e.g., being processed by a first model, and subsequently processed by a second model based on an output of the first model), the cascade machine learning model system may require the request to be processed through multiple different machine learning models even though one or more of the different models (but not all of the models in the cascade machine learning model system) may be able to accurately process the request. In another example, due to one or more outliers where the cascade machine learning model system was not able to process the requests accurately, a system administrator may exclude requests that satisfy a set of criteria (e.g., transactions that were originated from a particular region, etc.) to be processed by the cascade machine learning model system. The set of exclusion criteria may be over-encompassing such that some of the requests that could be processed accurately by the cascade machine learning model system may be excluded from being processed by the cascade machine learning model system due to the exclusion criteria.

As such, the transaction processing system of some embodiments may generate an efficacy determination model configured to predict an efficacy of the cascade machine learning model system and/or the efficacies of the individual machine learning models within the cascade machine learning model system in performing the task. The efficacy determination model of some embodiments may be implemented as a machine learning model (e.g., an artificial neural network, a gradient boosting tree, etc.). In some embodiments, the output(s) of the efficacy determination model may indicate a predicted accuracy of the cascade machine learning model system as a whole and/or the predicted accuracies of the individual machine learning models within the cascade machine learning model system.

In order to configure and train the efficacy determination model, the transaction processing system may determine various prediction accuracy categories for the cascade machine learning model system. Each prediction category may represent whether one or more machine learning models within the cascade machine learning model system has made an accurate prediction or not. Using the example illustrated above where the cascade machine learning model system includes two machine learning models configured to classify transactions as either fraudulent transactions or non-fraudulent transactions, the cascade machine learning model system may be configured to operate according to a particular cascade operation scheme, where a first machine learning model may perform a first pass of classification for any given transaction. If the first machine learning model classifies the transaction as a non-fraudulent transaction, since the first machine learning model has been configured and trained to have an acceptable accuracy for classifying transactions as non-fraudulent transactions, the cascade machine learning model system may terminate the classification process, and use the classification generated by the first machine learning model as an output of the cascade machine learning model system. On the other hand, if the first machine learning model classifies the transaction as a fraudulent transaction, the cascade machine learning model system may use the second machine learning model to re-classify the transaction. The second machine learning model may classify the transaction as fraudulent transaction or a non-fraudulent transaction.

Thus, the transaction processing system may determine that there are three possible joint classifications from the different machine learning models in the cascade machine learning model system: a first possible joint classification corresponding to the first machine learning model classifying the transaction as a non-fraudulent transaction, a second possible joint classification corresponding to the first machine learning model classifying the transaction as a fraudulent transaction and the second machine learning model subsequently classifying the transaction as a non-fraudulent transaction, and a third possible joint classification corresponding to the first machine learning model classifying the transaction as a fraudulent transaction and the second machine learning model subsequently classifying that the transaction as a fraudulent transaction. Since each classification generated by a machine learning model in the cascade machine learning model system can be either accurate (e.g., a correct classification, such as when the transaction is indeed fraudulent when the predicted classification indicates that the transaction is fraudulent or vice versa, etc.) or inaccurate (e.g., an incorrect classification, such as when the transaction is actually fraudulent when the predicted classification indicates that the transaction is non-fraudulent or vice versa, etc.), there may be a total of six different accuracy categories for this particular example of cascade machine learning model system, where each joint classification can either be accurate or inaccurate.

In some embodiments, the transaction processing system may configure and train the efficacy determination model to predict, given a transaction, a likelihood that each of the machine learning models in the cascade machine learning model system would accurately classify the transaction. Thus, the transaction processing system may generate training data based on past requests (e.g., past classifications) by first determining an accuracy category for each past request (e.g., based on whether each machine learning model provided an accurate prediction or not) and labeling that past request with the accuracy category. In some embodiments, the transaction processing system may assign different values to the different accuracy categories. The values assigned to the transaction processing system may be determined in an order based on how desirable the accuracy categories are to the transaction processing system. For example, the transaction processing system may determine that the accuracy category (or accuracy categories) that corresponds to scenarios when all of the machine learning models in the cascade machine learning model system produce accurate predictions as the most desirable outcome, and thus may assign a highest value to that accuracy category (or accuracy categories). The transaction processing system may determine that the accuracy category (or accuracy categories) that corresponds to scenarios when all of the machine learning models in the cascade machine learning model system produce inaccurate predictions as the least desirable outcome, and thus may assign a lowest value to that accuracy category (or accuracy categories).

The transaction processing system may also determine that the accuracy category (or accuracy categories) that corresponds to scenarios when some of the machine learning models (but not all) in the cascade machine learning model system produce accurate predictions as moderately desirable outcomes, and thus may assign a value between the highest value and the lowest value to that accuracy category (or accuracy categories). In some embodiments, the transaction processing system may also assign different values when a different machine learning model produces an accurate prediction. For example, the transaction processing system may assign a first value for the accuracy category that corresponds to an accurate prediction by a first machine learning model and an inaccurate prediction by a second machine learning model. The transaction processing system may also assign a second value (different from the first value) for the accuracy category that corresponds to an accurate prediction by the second machine learning model and an inaccurate prediction by the first machine learning model.

The transaction processing system may then train the efficacy determination model using the generated training data. When a new request (e.g., a new classification request associated with a transaction, etc.) is received, the transaction processing system may first provide the request to the efficacy determination model. The transaction processing system may determine, based on an output from the efficacy determination model, the likelihood that the cascade machine learning model would provide an accurate prediction for that request, and the likelihoods that each of the machine learning models in the cascade machine learning model would provide accurate predictions for that request. The transaction processing system may then process the request based on the output from the efficacy determination model.

For example, the transaction processing system may determine to use the cascade machine learning model system to perform a prediction for the request when the output indicates that the likelihood of the cascade machine learning model system making an accurate prediction for the request is above a threshold. This way, even if the request satisfies a set of predetermined exclusion criteria that would normally exclude the request from being processed by the cascade machine learning model system, the transaction processing system may make an exception from that exclusion based on the output. Similarly, the transaction processing system may determine not to use the cascade machine learning model system (and choose to use another method, such as another machine learning model, etc., for processing the request) to perform a prediction for the request when the output indicates that the likelihood of the cascade machine learning model system making an accurate prediction for the request is below the threshold.

In some embodiments, when the likelihood exceeds the threshold, the transaction processing system may also determine how to use the cascade machine learning model system to process the request (e.g., produce a prediction such as a classification for a transaction). In some embodiments, the transaction processing system may determine to deviate from the cascade operation scheme that is associated with the cascade machine learning model system based on the output from the efficacy determination model (i.e., modifying one or more characteristics of the cascade machine learning model system). For example, when the output from the efficacy determination model indicates that the first model would likely produce an accurate prediction for this request, the transaction processing system may determine to use the prediction from the first machine learning model as an output for the cascade machine learning model system, regardless of what the prediction is (e.g., even if the prediction of the first machine learning model requires the request to be processed by at least a second machine learning model according to the cascade operation scheme). In another example, when the output from the efficacy determination model indicates that the first model would likely produce an inaccurate prediction for this request, the transaction processing system may determine to bypass the first machine learning model, and provide the request directly to the second machine learning model of the cascade machine learning model system in order to reduce the time and computer resources required to process the request.

By dynamically changing the way that requests are being processed by the cascade machine learning model system based on outputs provided by the efficacy determination model using the techniques discussed herein, the transaction processing system improves both the accuracy and utilization rate of the cascade machine learning model system.

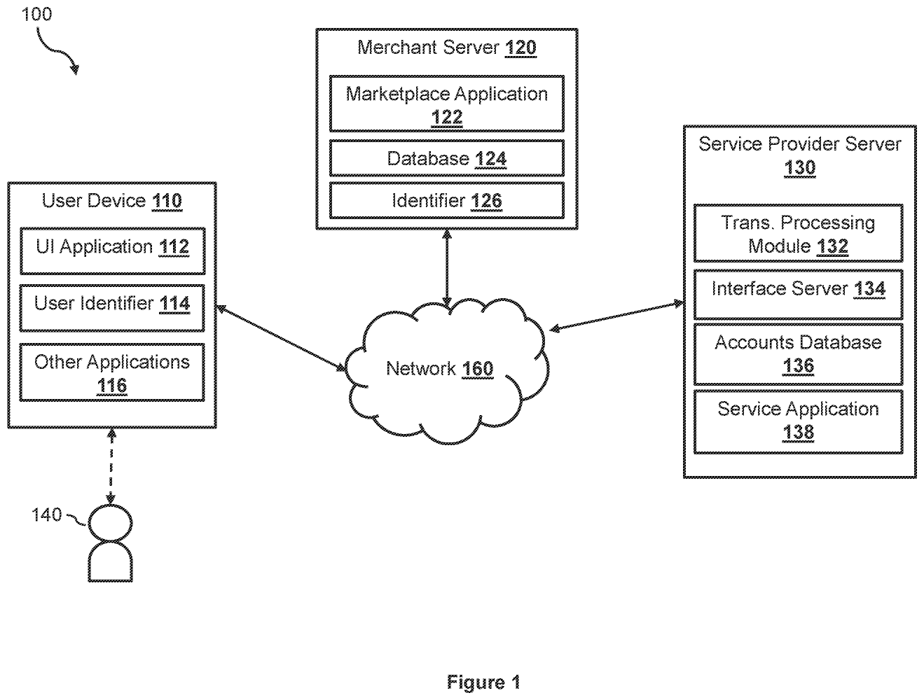

FIG. 1 illustrates an electronic transaction system 100, within which the transaction processing system may be implemented according to one embodiment of the disclosure. The electronic transaction system 100 includes a service provider server 130, a merchant server 120, and a user device 110, that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120 respectively. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to add a new funding account, to perform an electronic purchase with a merchant associated with the merchant server 120, to provide information associated with the new funding account, to initiate an electronic payment transaction with the service provider server 130, to apply for a financial product through the service provider server 130, to access data associated with the service provider server 130, etc.).

While only one user device 110 is shown in FIG. 1, it has been contemplated that multiple user devices, each associated with a different user, may be connected to the merchant server 120 and the service provider server 130 via the network 160.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for purchase and process payments for the purchases. The merchant server 120 may include a merchant database 124 for identifying available items or services, which may be made available to the user device 110 for viewing and purchase by the user.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a transaction processing module 132 that implements the transaction processing system as discussed herein. The transaction processing module 132 may be configured to process transaction requests received from the user device 110 and/or the merchant server 120 via the interface server 134. In some embodiments, depending on the type of transaction requests received via the interface server 134 (e.g., a login transaction, a data access transaction, a payment transaction, etc.), the transaction processing module 132 may use different machine learning models to perform different tasks associated with the transaction request. For example, the transaction processing module 132 may use various machine learning models to analyze different aspects of the transaction request (e.g., a fraudulent transaction risk, a chargeback risk, a recommendation based on the request, etc.). The machine learning models may produce outputs that indicate a risk (e.g., a fraudulent transaction risk, a chargeback risk, a credit risk, etc.) or indicate an identity of a product or service to be recommended to a user. The transaction processing module 132 may then perform an action for the transaction request based on the outputs. For example, the transaction processing module 132 may determine to authorize the transaction request (e.g., by using the service applications 138 to process a payment transaction, enabling a user to access a user account, etc.) when the risk is below a threshold, and may deny the transaction request when the risk is above the threshold.

In some embodiments, to perform the various tasks associated with the transaction request (e.g., assess a fraudulent risk of the transaction request, assessing a chargeback risk, generating a recommendation, etc.), the machine learning models may use attributes related to the transaction request, the user who initiated the request, the user account through which the transaction request is initiated, a merchant associated with the request, and other attributes during the evaluation process to produce the outputs. Example attributes for performing the tasks may include device attributes of the user device 110 (e.g., a device identifier, a network address, a location of the user device 110, etc.), attributes of the user 140 (e.g., a transaction history of the user 140, a demographic of the user 140, an income level of the user 140, a risk profile of the user 140, etc.), attributes of the transaction (e.g., an amount of the transaction, a time of day when the transaction is initiated, a type of transaction, etc.), and other information related to the transaction.

In some embodiments, the transaction processing module 132 may use one or more cascade machine learning model systems to perform the task(s) for each given transaction. As discussed herein, using a cascade operation scheme that involves different machine learning models to perform the tasks in a cooperative manner can improve the speed performance in performing the tasks.

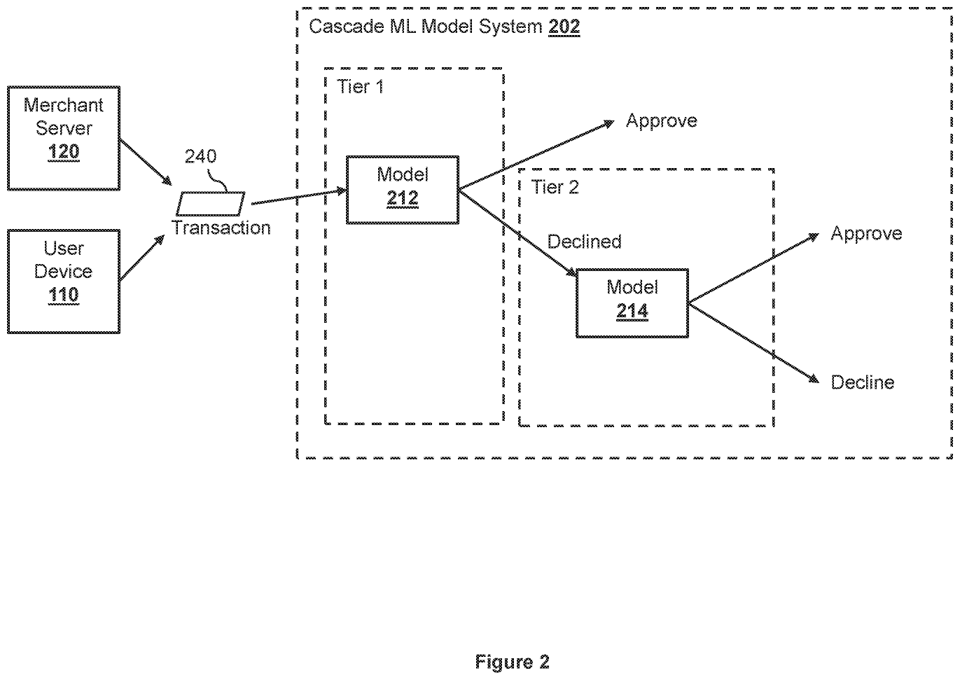

FIG. 2 illustrates an example cascade machine learning model system 202 that can be utilized by the transaction processing module 132 in performing the tasks (e.g., assessing a risk of a transaction, etc.) according to various embodiments of the disclosure. As shown, the cascade machine learning model system 202 includes a two-tier structure comprising a first tier (Tier 1) that includes a machine learning model 212 and a second tier (Tier 2) that includes a machine learning model 214. Each of the machine learning models 212 and 214 may be configured to determine a risk associated with a transaction (e.g., whether the transaction is a fraudulent transaction or a non-fraudulent transaction).

In some embodiments, the machine learning model 212 in Tier 1 of the cascade machine learning model system 202 may be less complex than the machine learning model 214 in Tier 2 of the cascade machine learning model system 202. For example, the machine learning model 212 may be implemented using a simpler type of machine learning model structure than the machine learning model 214 (e.g., the machine learning model 212 may be implemented as a decision tree while the machine learning model 214 may be implemented as an artificial neural network, etc.). In another example where the machine learning models 212 and 214 are both implemented using the same type of machine learning model structure (e.g., an artificial neural network), the machine learning model 212 may include a simpler structure (e.g., configured to receive less input features, having a lower number of hidden layers, having less connectivity among nodes in the hidden layers, etc.) than the machine learning model 214. This way, the machine learning model 212 may perform the task (e.g., classifying transactions) much quicker than the machine learning model 214 even though the machine learning model 214 may provide more accurate results than the machine learning model 212.

In some embodiments, the cascade machine learning model system 202 may be configured to operate according to a particular cascade operation scheme. In this example, the particular cascade operation scheme may specify that as a transaction (e.g., a transaction 240) is received (e.g., from the merchant server 120 and/or the user device 110), data associated with the transaction may initially be provided to the machine learning model 212. The machine learning model 212 may be configured to classify the transaction 240 based on the data as either a fraudulent transaction or a non-fraudulent transaction. Since the machine learning model 212 can perform the task (e.g., classifying the transaction) much more quickly than the machine learning model 214, the transaction processing module 132 may obtain a preliminary classification from the machine learning model 212 quickly.

In some embodiments, in order to maximize the limited capability of the machine learning model 212, the transaction processing module 132 of some embodiments may configure and train the machine learning model 212 to have a bias in predicting transactions as a particular classification (e.g., non-fraudulent transactions). That is, the transaction processing module 132 may generate and use a loss function during the training phase of the machine learning model 212 such that after training the machine learning model 212 with a set of training data based on the loss function, the machine learning model 212 would have a higher accuracy performance (e.g., having a false positive rate below a threshold) when classifying transactions as non-fraudulent transactions than classifying transactions as any other classification (e.g., fraudulent transactions). Due to the limited capability of the machine learning model 212, such a bias may cause the machine learning model 212 to have an unacceptable accuracy performance (e.g., having a false positive rate above the threshold) when classifying transactions as fraudulent transactions.

Thus, based on this bias, the cascade operation scheme may specify that if the machine learning model 212 classifies the transaction 240 as a non-fraudulent transaction, the cascade machine learning model system 202 may accept such a classification without going through the machine learning model 214 in Tier 2 of the cascade machine learning model system 202. Based on the non-fraudulent transaction classification, the cascade machine learning model system 202 may indicate to the transaction processing module 132 to approve the transaction 240. The transaction processing module 132 may process the transaction 240 accordingly (e.g., processing a payment between a sender and a receiver, enabling a user to login to a user account, etc.).

However, if the machine learning model 212 classifies the transaction 240 as a fraudulent transaction, due to the possible unacceptable accuracy performance of the machine learning model 202 in such a classification (e.g., a false positive rate exceeding a threshold, etc.), the cascade operation scheme may specify that the transaction 240 be classified again by the machine learning model 214 in Tier 2 of the cascade machine learning model system 202. Since the machine learning model 214 is more complex, the machine learning model 214 can classify the transaction 240 more accurately than the machine learning model 212, albeit taking a longer time. The machine learning model 214 may classify the transaction 240 as either a fraudulent transaction or a non-fraudulent transaction (e.g., even when the machine learning model 212 classifies the transaction as a fraudulent transaction, the machine learning model 214 may still classify the transaction as a non-fraudulent transaction, etc.). The cascade machine learning model system 202 may use the classification provided by the machine learning model 214 as the output of the cascade machine learning model system 202 for the transaction processing module 132. The output may indicate whether to approve or decline the transaction (e.g., approve if the machine learning model 214 classifies the transaction 240 as a non-fraudulent transaction and decline if the machine learning model 214 classifies the transaction 240 as a fraudulent transaction, etc.). The transaction processing module 132 may then process the transaction 240 according to the output (e.g., processing or declining a payment between a sender and a receiver, allowing or disallowing a user to login to a user account, etc.).

Such a cascade operations scheme enables the cascade machine learning model system 202 to provide a significant improvement in processing speed for many transactions that are non-fraudulent (the transactions that are classified as non-fraudulent by the machine learning model 212) since those transactions are only processed by the quicker and simpler machine learning model 212, without sacrificing the overall accuracy performance (as the transactions that are classified as fraudulent will be processed again by the slower, but more accurate machine learning model 214).

In some embodiments, the transaction processing module 132 may collectively select hyperparameters for all of the machine learning model within the cascade machine learning model system 202 to improve the overall accuracy performance of the cascade machine learning model system 202. Hyperparameters in a machine learning model are parameters that control the learning (training) process of the machine learning model. Example hyperparameters for a machine learning model may include a learning rate, a solver, a regularization constant, an activation value, a selection of an optimization algorithm, a train-test split ratio, a selection of a loss function (from multiple different available loss functions, etc.), a number of hidden layers if the model is a neural network, a dropout rate in neural network, etc. These hyperparameters are determined prior to the training process and are used to control how the training process is conducted, which in turn may affect how the machine learning model will turn out.

As discussed herein, conventionally, each machine learning model within a cascade machine learning model system may be configured and trained independently (in silo) from the other machine learning models within the cascade machine learning model system. However, while such a way of determining the hyperparameters may optimize the performance of the different models when they are operated independently, those hyperparameters may not be selected to optimize the performance of the different models when they are operated together (e.g., in a cascade manner) within the cascade machine learning model system.

As such, in order to improve the overall accuracy performance of the cascade machine learning model system 202, the transaction processing module 132 may configure and train the different machine learning models (the machine learning model 212 and the machine learning model 214) within the cascade machine learning model system 202 collectively such that the overall performance of the cascade machine learning model system 202 (when the machine learning models 212 and 214 are operated together according to the cascade operation scheme of the cascade machine learning model system 202) can be optimized.

In some embodiments, the transaction processing module 132 may determine hyperparameters for each of the machine learning models 212 and 214 within the cascade machine learning model system 202, and may determine hyperparameter values for both of the machine learning models 212 and 214 collectively to optimize the performance of the cascade machine learning model system 202. If the machine learning model 212 is implemented using a different type of machine learning model structure than the machine learning model 214, the hyperparameters for the machine learning model 212 may be different from the hyperparameters for the machine learning model 214. However, even if both of the machine learning models 212 and 214 are implemented using the same type of machine learning model structure (e.g., both are implemented as artificial neural networks, etc.), different hyperparameter values may be selected for configuring and training each of the machine learning models 212 and 214.

In one example, the transaction processing module 132 may determine a first set of hyperparameters that can be used to configure and train the machine learning model 212 and a second set of hyperparameters that can be used to configure and train the machine learning model 214, where the first set of hyperparameters and the second set of hyperparameters may or may not include one or more common hyperparameters. The transaction processing module 132 may merge the two sets of hyperparameters to form a joint set of hyperparameters. By choosing different hyperparameter values for each of the hyperparameter in the joint set of hyperparameters, the transaction processing module 132 may generate different joint hyperparameter configurations for the cascade machine learning model system 202.

In some embodiments, the transaction processing module 132 may determine possible hyperparameter values (e.g., a range, a discrete set of possible values, etc.) for each of the hyperparameters in the joint set of hyperparameters. The transaction processing module 132 may then select an initial set of hyperparameter values for the joint set of hyperparameters for a first joint hyperparameter configuration. For example, if a hyperparameter is associated with a discrete set of possible values, the transaction processing module 132 may select one of the possible values for that hyperparameter. If a hyperparameter is associated with a range of values, the transaction processing system may select a value within the range for that hyperparameter. The transaction processing module 132 may then change the hyperparameter value(s) corresponding to at least one hyperparameter to generate other joint hyperparameter configurations.

The transaction processing module 132 may then generate different instances of the cascade machine learning model system 202 using different joint hyperparameter configurations, where each instance of the cascade machine learning model system 202 is generated by configuring and training the machine learning models 212 and 214 within the cascade machine learning model system 202 together using a distinct joint hyperparameter configuration. In some embodiments, the transaction processing module 132 may generate training data for training the different instances of the cascade machine learning model system 202 using previously conducted transactions. Each set of transaction data may include data related to a previously conducted transaction and a label corresponding to a determination of whether the transaction is a fraudulent transaction or a non-fraudulent transaction (can be determined with by human administrator manually or by another model).

The transaction processing module 132 may evaluate the accuracy performance of the different instances of the cascade machine learning model system using a validation data set. In the example where the cascade machine learning model system 202 is configured to classify transactions, the validation data set may also include transaction data associated with previously conducted transactions (which may be the same or different from the training data set used to train the different instances of the cascade machine learning model system). The transaction processing module 132 may identify a particular instance of the cascade machine learning model system 202 that has the highest accuracy performance, and determine to deploy the particular instance of the cascade machine learning model system 202 for use in a live environment.

However, when the number of joint hyperparameter configurations determined by the transaction processing module 132 is large (e.g., above a threshold number), for example, due to a large number of hyperparameters associated with the machine learning models 212 and 214, the time and the computer resources required to configure, train, and evaluate the different instances of the cascade machine learning model system 202 may be excessive (e.g., exceeding a time and/or computer resource constraint). In order to reduce the amount of time and computer resources (or to limit the time and computer resources within the constraint) for selecting an optimal joint hyperparameter configuration for the cascade machine learning model system 202, the transaction processing module 132 of some embodiments may adopt a successive halving technique in configuring, training, and evaluating the different instances of the cascade machine learning model system 202.

Using the successive halving technique, the transaction processing module 132 may train and evaluate the different instances of the cascade machine learning model system 202 in a sequence of iterations. In each iteration, the transaction processing module 132 may remove half of the instances of the cascade machine learning model system 202 that have worse accuracy performance than the remaining half of the instances of the cascade machine learning model system 202. The transaction processing module 132 may iteratively train instances of the cascade machine learning model system 202 and then remove half of the instances of the cascade machine learning model system 202 until only one instance of the cascade machine learning model system remains. In some embodiments, the transaction processing module 132 may use only a portion of the available training data to train the instances of the cascade machine learning model system 202 and use only a portion of the available validation data to evaluate the instances of the cascade machine learning model system 202 in each iteration, such that the instances of the cascade machine learning model system 202 may continuously be trained using a different portion of the available training data in each iteration.

For example, during the first iteration, the transaction processing module 132 may use a first portion of the training data to train the different instances of the cascade machine learning model system (each instance was configured and trained based on a different joint hyperparameter configuration). The transaction processing module 132 may evaluate the instances of the cascade machine learning model system 202 using a first portion of the validation data, and remove half of the instances of the cascade machine learning model system 202 having worse accuracy performance than the remaining half of the instances of the cascade machine learning model system 202. It is noted that the evaluation is performed on different instances of the entire cascade machine learning model system 202, that is, the evaluation is on the collective output produced by the machine learning models 212 and 214 working together. The transaction processing module 132 may assess the performance of the cascade machine learning model system 202 under different configurations as a whole, rather than evaluating the machine learning models 212 and 214 individually.

While using only a portion (e.g., less than half, such as 10%) of the training data to train the instances of the cascade machine learning model system 202 may limit the way that the different machine learning models in the cascade machine learning model system 202 perform (and be evaluated), it should be sufficient for the transaction processing module 132 to identify the worst half of the instances of the cascade machine learning model system 202.

After removing half of the instances of the cascade machine learning model system 202, the transaction processing system may then train the remaining half of the instances of the cascade machine learning model system 202 using a second portion of the training data. Since that remaining half of the instances of the cascade machine learning model system 202 has already been trained using the first portion of the training data, the training during the second iteration is added on (e.g., successive) to the remaining half of the instances of the cascade machine learning model system 202. While the instances of the cascade machine learning model system 202 may only be trained using a small portion of the available training data during the first iteration, as the transaction processing module 132 continues to train and evaluate the different instances of the cascade machine learning model system 202, the remaining instances of the cascade machine learning model system 202 is receiving more and more training. Thus, as the evaluation of the instances of the cascade machine learning model system 202 becomes more crucial (when the remaining number of instances of the cascade machine learning model system 202 is smaller, such as below a threshold), the instances of the cascade machine learning model have been trained with a larger amount of training data, which enables the transaction processing module 132 to be more accurately separate good performers from bad performers.

By using the successive halving technique, the majority of the instances of the cascade machine learning model system 202 (especially the bad performers that are removed in the earlier iterations) is trained using only a small portion of the available training data, which significantly reduces the time and computer resources required to evaluate those instances of the cascade machine learning model system 202. However, the good performers (the instances of the cascade machine learning model system that remains during the last few iterations) are trained using a larger portion of the available training data (or even the entire available training data), which enables the transaction processing module 132 to more accurately and precisely evaluate the instances of the cascade machine learning model system 202 and identify the optimal instance of the cascade machine learning model system 202 for deployment. Since the instance of the cascade machine learning model system 202 (and its associated joint hyperparameter configuration) is selected based on the collective performance of the different models working together in the cascade machine learning model system 202, the joint hyperparameter configuration selected for the cascade machine learning model system 202 would provide optimal accuracy performance for the cascade machine learning model system 202 as a whole.

After selecting the joint hyperparameter configuration for the cascade machine learning model system 202, the transaction processing module 132 may configure and train the cascade machine learning model system 202, and the machine learning models 212 and 214 within the cascade machine learning model system, using the selected joint hyperparameter configuration. The transaction processing module 132 may begin using the cascade machine learning model system 202 to perform the task (e.g., classifying transactions such as the transaction 240 received from the merchant server 120 and/or the user device 110, etc.).

However, as discussed herein, the rigid structure of the cascade machine learning model system 202 according to the cascade operation scheme may reduce the utilization rate of the cascade machine learning model system. For example, requests that can likely be classified correctly by the machine learning model 212 or the machine learning model 214 may be forced to go through the different models according to the cascade operation scheme of the cascade machine learning model system 202, where unnecessary resources (e.g., time and/or computer resources) may be wasted. In another example, due to one or more anomalies of certain transactions, a human administrator (or another computer module) may overgeneralize certain prediction patterns and may determine that the cascade machine learning model system 202 is not capable of accurately classifying a certain group of transactions (e.g., transactions that are originated from a particular country, etc.), such that any transactions that is part of the group (e.g., any transactions that are originated from the particular country) may be excluded from using the cascade machine learning model system 202, which may unnecessarily reduce the utilization rate of the cascade machine learning model system 202.

As such, according to various embodiments of the disclosure, the transaction processing module 132 may provide a framework for utilizing the cascade machine learning model system 202 that would improve the performance and the utilization rate of the cascade machine learning model system 202. In some embodiments, the framework may include an efficacy determination model that is configured and trained to predict an efficacy of the cascade machine learning model system 202 and/or each machine learning model in the cascade machine learning model system 202 in processing (e.g., accurately classifying) a given transaction. Based on the determined efficacy of the cascade machine learning model system 202 and/or each machine learning model in the cascade machine learning model system 202, the transaction processing module 132 may determine to use (or not use) the cascade machine learning model system 202 to process the given transaction. If the transaction processing module 132 determines to use the cascade machine learning model system 202 to process the given transaction, the transaction processing module 132 may also modify one or more characteristics of the cascade machine learning model system 202 in processing (e.g., classify) the given transaction based on the output from the efficacy determination model. By modifying the one or more characteristics of the cascade machine learning model system 202, the cascade machine learning model system may deviate from the cascade operation scheme when processing the given transaction. For example, the modified characteristics may specify to use only the machine learning model 212 or the machine learning model 214 for processing the given transaction regardless of the resulting classification.

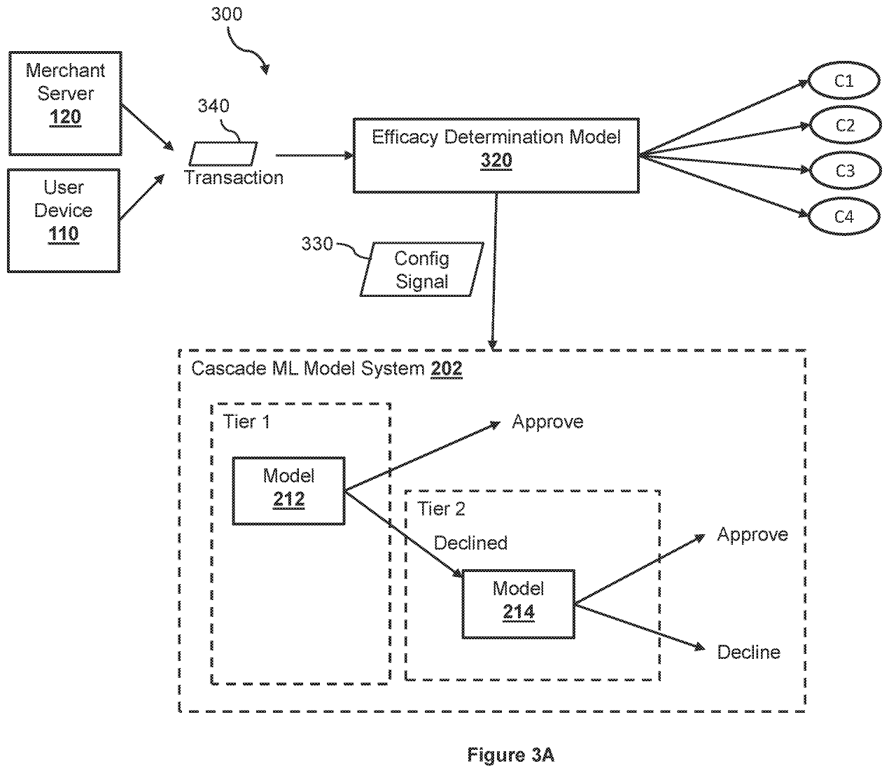

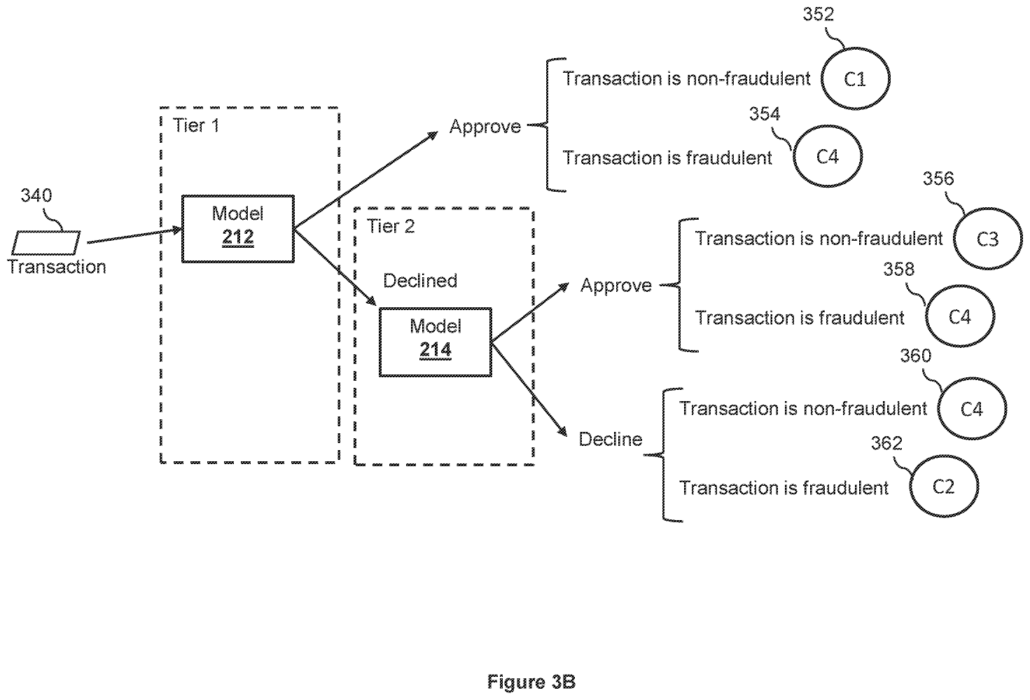

FIG. 3A illustrates an example framework 300 utilized by the transaction processing module 132 to improve the performance and utilization rate of the cascade machine learning model system 202. As shown, the framework 300 includes an efficacy determination model 320. In some embodiments, the efficacy determination model 320 can be implemented as a machine learning model (e.g., a transformer, an artificial neural network, a gradient boosting tree, etc.) that is configured and trained to determine an efficacy of the cascade machine learning model system 202 and/or each of the machine learning models 212 and 214 within the cascade machine learning model system 202 for a given transaction (e.g., a transaction 340). In some embodiments, the efficacy determination model 320 may be configured to receive data associated with the transaction 340 (e.g., attributes of the transaction that can be used as input to the cascade machine learning model system 202) and produce an output. The output of the efficacy determination model 320 may indicate how accurate the cascade machine learning model system 202 and/or each of the machine learning models 212 and 214 within the cascade machine learning model system 202 are in classifying the transaction 340.

Based on the output from the efficacy determination model 320, the transaction processing module 132 may generate a configuration signal 330 and transmit the configuration signal 330 to the cascade machine learning model system 202. The cascade machine learning model system 202 may then process the transaction 340 differently based on the configuration signal 330. For example, the transaction processing module 132 may generate the configuration signal 330 to cause the cascade machine learning model system 202 to completely ignore the transaction 340 when the output from the efficacy determination model 320 indicates that the cascade machine learning model system 202 cannot classify the transaction 340 with an acceptable accuracy (e.g., an accuracy above a threshold). In such a scenario, the transaction processing module 132 may use another computer module (e.g., another machine learning model, etc.) to process/classify the transaction 340.

In another example, the transaction processing module 132 may generate the configuration signal 330 to cause the cascade machine learning model system 202 to process (e.g., classify) the transaction 340 when the output from the efficacy determination model 320 indicates that the cascade machine learning model system 202 can classify the transaction 340 with an acceptable accuracy (e.g., an accuracy above a threshold). In some embodiments, the configuration signal 330 may also cause the cascade machine learning model system 202 to process the transaction 340 in a particular way (which may be different from the cascade operation scheme associated with the cascade machine learning model system 202). For example, the transaction processing module 132 may generate the configuration signal 330 to cause the cascade machine learning model system 202 to only use the machine learning model 212 to process (e.g., classify) the transaction 340 (e.g., bypassing the machine learning model 214) when the output from the efficacy determination model 320 indicates that the machine learning model 212 can classify the transaction 340 with an acceptable accuracy (e.g., an accuracy above a threshold). In another example, the transaction processing module 132 may generate the configuration signal 330 to cause the cascade machine learning model system 202 to only use the machine learning model 214 to process (e.g., classify) the transaction 340 (e.g., bypassing the machine learning model 212) when the output from the efficacy determination model 320 indicates that the machine learning model 212 cannot classify the transaction 340 with an acceptable accuracy (e.g., an accuracy above a threshold), but the machine learning model 214 can classify the transaction 340 with an acceptable accuracy (e.g., an accuracy above a threshold).

In some embodiments, in order to configure and train the efficacy determination model 320, the transaction processing module 132 may determine various prediction accuracy categories for the cascade machine learning model system 202. Each prediction category may represent whether one or more machine learning models within the cascade machine learning model system 202 can make an accurate prediction or not. In this example, the cascade machine learning model system 202 includes two machine learning models 212 and 214. Each of the machine learning models 212 and 214 is configured to classify transactions as either fraudulent transactions or non-fraudulent transactions according to the cascade operation scheme.

FIG. 3B illustrates the different possible classification outcomes produced by the cascade machine learning model system 202. For example, a first classification outcome may correspond to the machine learning model 212 classifying the transaction 340 as a non-fraudulent transaction, and the cascade machine learning model system 202 determines to approve the transaction 340 based on the classification. A second classification outcome may correspond to the machine learning model 212 classifying the transaction 340 as a fraudulent transaction, and the machine learning model 214 then re-classifying the transaction 230 as a non-fraudulent transaction. Under the second classification outcome, the cascade machine learning model system 202 may still approve the transaction 340 based on the re-classification by the machine learning model 214. A third classification outcome may correspond to the machine learning model 212 classifying the transaction 340 as a fraudulent transaction, and the machine learning model 214 then re-classifying the transaction 340 as a fraudulent transaction. Under the third classification outcome, the cascade machine learning model system 202 may declines the transaction based on the classification from the machine learning model 214.

Since each classification outcome generated by the machine learning model 212 and/or the machine learning model 214 in the cascade machine learning model system 202 can be either accurate (e.g., a correct classification, such as when the transaction is indeed fraudulent when the predicted classification indicates that the transaction is fraudulent or vice versa, etc.) or inaccurate (e.g., an incorrect classification, such as when the transaction is actually fraudulent when the predicted classification indicates that the transaction is non-fraudulent or vice versa, etc.), the transaction processing module 132 may determine a total of six different accuracy categories 352, 354, 356, 358, 360, and 362 for this particular example of cascade machine learning model system 202, where each of the three classification outcomes can either be accurate or inaccurate. In this example, the accuracy category 352 corresponds to the scenario when the first classification outcome is accurate. The accuracy category 354 corresponds to the scenario when the first classification outcome is inaccurate. The accuracy category 356 corresponds to the scenario when the second classification outcome is accurate. The accuracy category 358 corresponds to the scenario when the second classification outcome is inaccurate. The accuracy category 360 corresponds to the scenario when the third classification outcome is accurate. The accuracy category 362 corresponds to the scenario when the third classification outcome is inaccurate.

Certain accuracy categories may be more favorable to the transaction processing module 132 than other accuracy categories. For example, the accuracy category 352 is very favorable as the cascade machine learning model system 202 only uses the machine learning model 212 to predict a classification, and the predicted classification is accurate. The accuracy category 362 is also very favorable (but may not be as favorable as the accuracy category 352) as both the machine learning models 212 and 214 made the accurate classification predictions. On the other hand, the accuracy category 356 is not as favorable as the accuracy categories 352 and 362, since the machine learning model 212 made an inaccurate classification prediction while the machine learning model 214 made an accurate classification prediction. Similarly, the accuracy category 358 is not very favorable, since the machine learning model 214 made an inaccurate classification prediction while the machine learning model 212 made an accurate classification prediction. Furthermore, the accuracy categories 354 and 360 are very unfavorable as both of the machine learning models 212 and 214 made inaccurate classification predictions.

In some embodiments, the transaction processing module 132 may assign different values to the different accuracy categories based on how favorable they are to the transaction processing module 132. In an non-limiting example, the transaction processing module 132 may assign a high value to the favorable accuracy categories, such as assigning 10 out of a maximum of 10 points to the accuracy category 352, assigning 9 out of 10 points to the accuracy category 362, and assigning 8 out of 10 points to the accuracy category 356. The transaction processing module 132 may also assign a low value to the accuracy categories that are unfavorable accuracy categories, such as assigning 0 out of 10 points to the accuracy category 360. The transaction processing module 132 may also assign medium amounts of points to the accuracy categories that are in between the favorable and unfavorable categories, such as assigning points between 0 and 7 (e.g., 4 out of 10 points) for accuracy categories 354 and 358.

The transaction processing module 132 may generate training data for training the efficacy determination model 320, for example, based on prior transactions that have been processed (e.g., classified) by the cascade machine learning model system 202. For example, the transaction processing module 132 may generate the training data by combining the transaction data associated with each previously processed transaction and a label indicating whether each of the machine learning models within the cascade machine learning model system 202 has correctly classified the previously processed transaction or not. In some embodiments, the label may represent an accuracy category corresponds to the processing of that previously processed transaction by the cascade machine learning model system 202. In some embodiments, the label may include a value that is assigned to the accuracy category. By training the efficacy determination model 320 using such training data, the efficacy determination model 320 may be configured and trained to produce an output (e.g., a value within the range between 0 and 10, etc.) for a given transaction that indicates an accuracy category that indicates how accurate will the cascade machine learning model system 202, and/or each of the machine learning models within the cascade machine learning model system 202 classify the given transaction. Thus, based on the output from the efficacy determination model 320, the transaction processing module 132 may determine whether the cascade machine learning model system 202 can accurately classify the given transaction, and how well each of the machine learning models within the cascade machine learning model system 202 can classify the given transaction. The transaction processing module 132 may then generate the configuration signal 330 based on the output, and transmit the configuration signal 330 to the cascade machine learning model system 202, such that the cascade machine learning model system 202 may process the given transaction according to the configuration system as discussed herein.

In some embodiments, the techniques for improving the accuracy performance and utilization rate described herein can be applied to different types of cascade machine learning model systems under various configurations. The cascade machine learning model system 202 illustrated above shows only one example configuration that includes two machine learning models in two tiers. Under different configurations, a cascade machine learning model system may include additional tiers (e.g., 3 tiers, 5 tiers, etc.) and/or more than one machine learning models in one or more of the tiers. For example, the cascade machine learning model system 202 may be extended to include additional tiers (e.g., Tier 3, Tier 4, etc.), such that when the machine learning model 214 declines a transaction, the cascade machine learning model system 202 may use another machine learning model in Tier 3 to re-classify the transaction. If the cascade machine learning model system 202 includes additional tiers, the cascade machine learning model system 202 may continue to use the machine learning model(s) in subsequent tiers to re-classify the transaction when the machine learning model in the previous tier classifies the transaction as a fraudulent transaction.

While the machine learning models 212 and 214 are both configured to the perform the same task (e.g., classifying transactions as fraudulent or non-fraudulent transactions) in the cascade machine learning model system 202, in some embodiments, different machine learning models within a cascade machine learning model system may be configured to perform different tasks. For example, a cascade machine learning model system may be configured to process a sequence of transactions that may be different from each other. When a typical sequence of transactions conducted by users of the service provider server 130 includes: logging into an account with the service provider server 130, checking a balance of the account, and then performing a payment transaction through the account. The transaction processing module 132 may then configure a cascade machine learning model system based on such a sequence of transactions, such that each tier of machine learning models may be configured to process (e.g., classify) a distinct transaction in the sequence of transactions. As such, the machine learning model(s) in the first tier may be configured to classify login transactions. Only when the machine learning model(s) in the first tier approves a login transaction (e.g., classifying the login transaction as a non-fraudulent transaction) would the cascade machine learning model system use the machine learning model(s) in the second tier to process (e.g., classify) the subsequent transaction (e.g., the balance checking transaction). Similarly, only when the machine learning model(s) in the second tier approves a balance checking transaction (e.g., classifying the balance checking transaction as a non-fraudulent transaction) would the cascade machine learning model system use the machine learning model(s) in the third tier to process (e.g., classify) the subsequent transaction (e.g., the payment transaction).

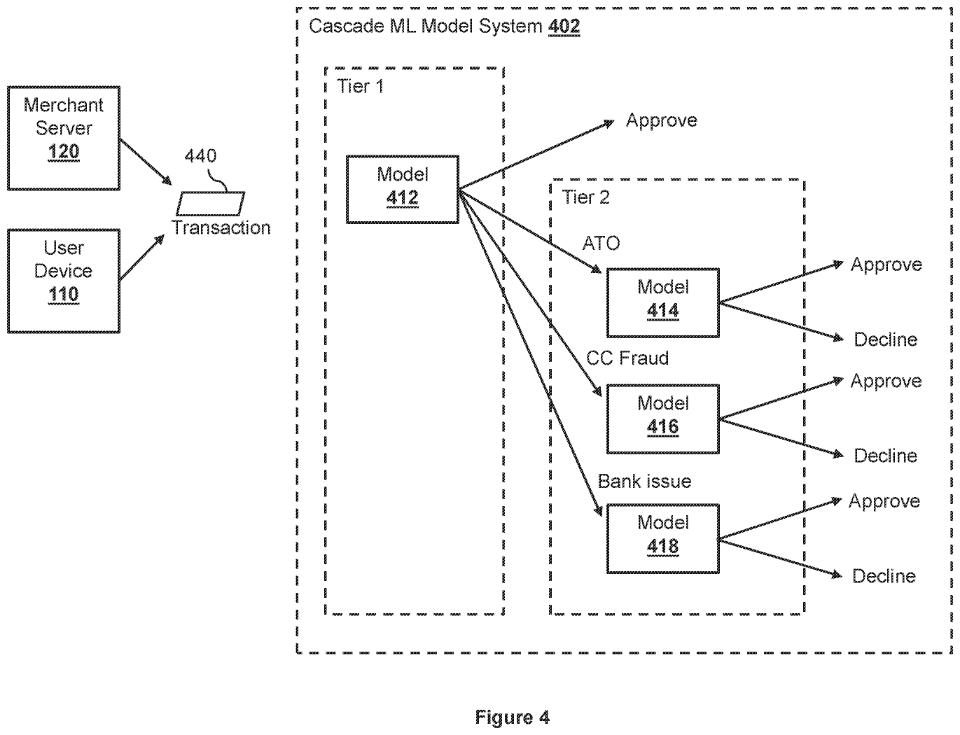

In some embodiments, the machine learning models within the same tier of the cascade machine learning model system may also be configured to perform different tasks. FIG. 4 illustrates an example cascade machine learning model system 402 that is configured under such an approach for processing (e.g., classifying) incoming transactions (e.g., a transaction 440). In this example, the cascade machine learning model system 402 has two tiers: Tier 1 and Tier 2. Tier 1 includes one machine learning model 412 while Tier 2 includes three machine learning models 414, 416, and 418. Unlike the machine learning model 212, the machine learning model 412 may be configured and trained to classify the transaction 440 into one of four different categories (instead of two categories). For example, the machine learning model 412 may classify the transaction 440 as a non-fraudulent transaction based on the transaction data (in which case the cascade machine learning model system 420 would then approve the transaction 440 without using any machine learning models in Tier 2). If the machine learning model 412 determines that the transaction 440 is a fraudulent transaction, the machine learning model 412 may further classify the transaction 440 as one of the three different fraud categories: (1) account take-over (ATO), (2) credit card fraud (CC Fraud), and (3) bank issues.

In this example, Tier 2 of the cascade machine learning model 402 includes three different machine learning models 414, 416, and 418, each corresponds to a different fraud category. For example, the machine learning model 414 is configured and trained specifically on detecting ATO fraud (e.g., classifying whether a transaction is associated with ATO fraud or not), the machine learning model 416 is configured and trained specifically on detecting CC fraud (e.g., classifying whether a transaction is associated with credit card fraud or not), and the machine learning model 418 is configured and trained specifically on detecting bank issue fraud (e.g., classifying whether a transaction is associated with bank issue fraud or not). Thus, based on the fraud category classification indicated by the machine learning model 412, the cascaded machine learning model system 402 may use one of the machine learning models 414, 416, and 418 to further process (e.g., re-classify) the transaction. The cascade machine learning model system 402 may then process (e.g., approve, decline, request additional data, etc.) the transaction 440 based on the output from one of the machine learning models 414, 416, and 418 in Tier 2.

Regardless of the configurations of the cascade machine learning model system, the transaction processing module 132 may use the techniques disclose herein to collectively select optimal hyperparameters for the machine learning models within the cascade machine learning model system, and to incorporate an efficacy determination model within a framework in order to improve the utilization rate of the cascade machine learning model system and to dynamically re-configure the cascade machine learning model system to operate differently based on the efficacy indications for each of the models within the cascade machine learning model system.

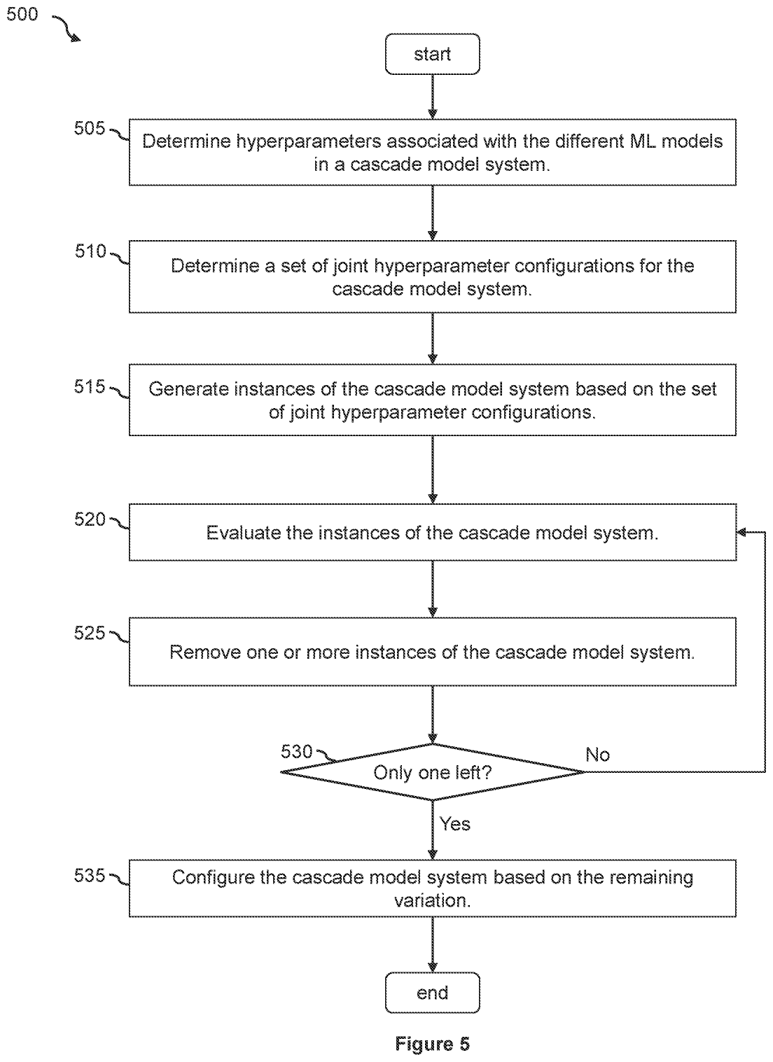

FIG. 5 illustrates a process 500 for determining hyperparameters for the machine learning models within a cascade machine learning model system according to various embodiments of the disclosure. In some embodiments, at least a portion of the process 500 may be performed by the transaction processing module 132. The process 500 begins by determining (at step 505) hyperparameters associated with the different machine learning models within the cascade model system. For example, the transaction processing module 132 may determine hyperparameters associated with the machine learning models 212 and 214 for the cascade machine learning model system 202. The hyperparameters can be used to control the learning process of the machine learning models 212 and 214. The transaction processing module 132 may then merge the hyperparameters associated with the machine learning models 212 and 214 to form a set of joint hyperparameters.

The process 500 then determines (at step 510) a set of joint hyperparameter configurations for the cascade model system and generates (at step 515) a set of instances of the cascade model system based on the set of joint hyperparameter configurations. For example, the transaction processing module 132 may generate an initial joint hyperparameter configuration by assigning a hyperparameter value to each of the hyperparameter for the machine learning models 212 and 214. The transaction processing module 132 may then generate additional joint hyperparameter configurations by varying one or more of the hyperparameter values such that each joint hyperparameter configuration may have at least one different hyperparameter value than other joint hyperparameter configurations. The transaction processing module 132 may then generate different instances of the cascade machine learning model system by training the cascade machine learning model system using the different joint hyperparameter configurations.

The process 500 evaluates (at step 520) the instances of the cascade model system, removes (at step 525) one or more instances of the cascade model system. For example, the transaction processing module 132 may evaluate the instances of the cascade machine learning model system 202 using validation data (e.g., determining how accurate each instance of the cascade machine learning model system 202 in classifying transactions). In some embodiments, the transaction processing module 132 may rank the instances of the cascade machine learning model system 202 based on how well the instances perform (e.g., how accurately they classify the transactions), and may remove a portion (e.g., half) of the instances that perform worse than the remaining of the instances of the cascade machine learning model 202.

The process 500 then determines (at step 525) whether only one instance is remaining after removing one or more instances of the cascade model system. If more than one instance remains, the process 500 reverts back to the step 520 and continue to evaluate the instances of the cascade model system and removes another portion of the instances based on the evaluating. However, if only one instance remains, the process 500 configures (at step 535) the cascade model system the remaining instance of the cascade model system. For example, the transaction processing module 132 may determine the joint hyperparameter configuration used to configure the remaining instance of the cascade machine learning model system 202, and may configure and train the cascade machine learning model system 202 using that joint hyperparameter configuration. The transaction processing module 132 may then deploy the trained cascade machine learning model system 202.

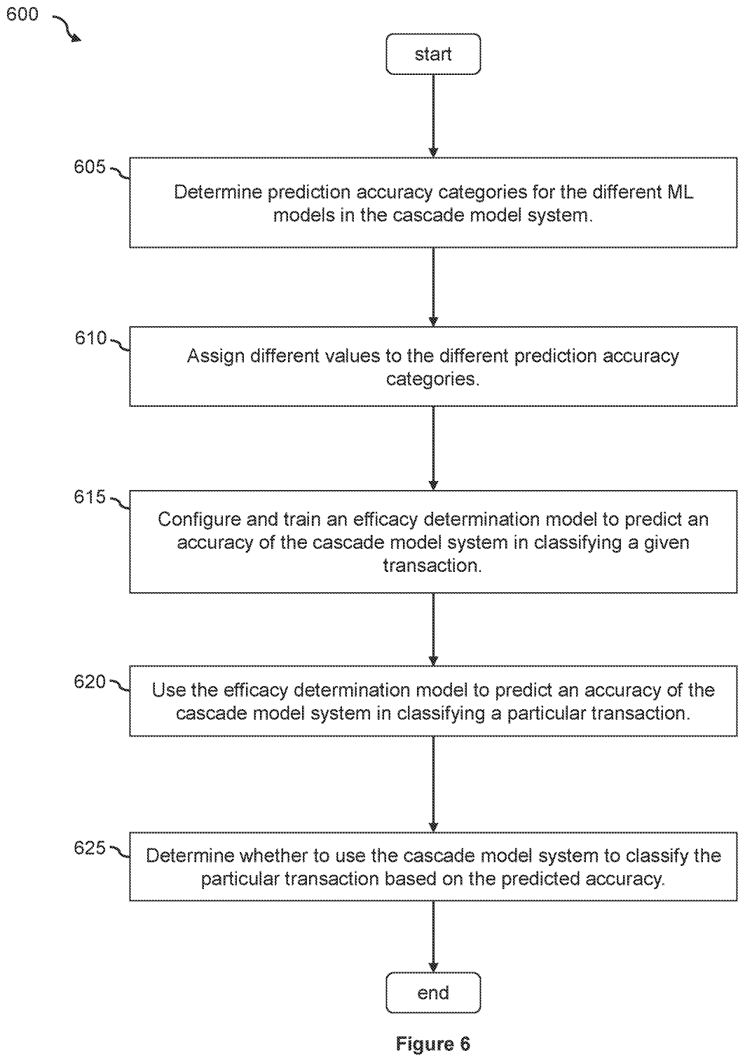

FIG. 6 illustrates a process 600 for generating a framework to improve accuracy performance and utilization rate of a cascade machine learning model system according to various embodiments of the disclosure. In some embodiments, at least a portion of the process 600 may be performed by the transaction processing module 132. The process 600 begins by determining (at step 605) prediction accuracy categories for the different machine learning models in the cascade model system and assigning (at step 610) different values to the different prediction accuracy categories. For example, the transaction processing module 132 may determine different possible outcomes from the cascade machine learning model system 202 based on the possible outputs from each of the machine learning models 212 and 214. Since each of the outcome can be accurate (e.g., correctly classifying a transaction) or inaccurate (incorrectly classifying a transaction), the transaction processing module 132 may determine a total of six accuracy categories for the cascade machine learning model system 202. The transaction processing module 132 may then assign different values to the different accuracy categories based on how favorable they are to the transaction processing module 132.

The process 600 configures and trains (at step 615) an efficacy determination model to predict an accuracy of the cascade model system in classifying a given transaction. For example, the transaction processing module 132 may configure the efficacy determination model 320 to produce a predicted accuracy category (or a value corresponding to a predicted accuracy category) based on transaction data associated with a given transaction. The output of the efficacy determination model 320 may indicate how well each of the machine learning models 212 and 214 within the cascade machine learning model system 202 can classify the given transaction. In some embodiments, the transaction processing module 132 may generate training data for the efficacy determination model 320 based on previously processed transactions by the cascade machine learning model system 202, and may train the efficacy determination model 320 using the training data.

The process 600 then uses (at step 620) the efficacy determination model to predict an accuracy of the cascade model system in classifying a particular transaction and determines (at step 625) whether to use the cascade model system to classify the particular transaction based on the predicted accuracy. For example, when the service provider server 130 receives a request to process a transaction (e.g., from the user device 110 and/or the merchant server 120), the transaction processing module 132 may determines how to process the transaction. In some embodiments, before providing the transaction to the cascade machine learning model system 202, the transaction processing module 132 may first use the efficacy determination model 320 to predict how accurate would the cascade machine learning model system 202 and/or each of the machine learning models 212 and 214 in classifying the transaction based on transaction data associated with the transaction. Thus, the transaction processing module 132 may provide the transaction data to the efficacy determination model 320 and obtain an output from the efficacy determination model 320. The output may indicate how accurate the cascade machine learning model system 202 and/or each of the machine learning models 212 and 214 in classifying the transaction. Based on the output, the transaction processing module 132 may generate a configuration signal 330 for configuring the cascade machine learning model system 202 in processing the transaction.

For example, if the output from the efficacy determination model 320 indicates that the cascade machine learning model system 202 as a whole would not be able to classify the transaction accurately, the configuration signal 330 may cause the cascade machine learning model system 202 to ignore the transaction. In such a scenario, the transaction processing module 132 may use another module (e.g., another machine learning model) to process the transaction. If the output from the efficacy determination model 320 indicates that the cascade machine learning model system 202 would be able to classify the transaction accurately, the configuration signal 330 may cause the cascade machine learning model system 202 to process the transaction in a particular way (e.g., process the transaction according to the normal cascade operation scheme, use only the machine learning model 212 to process the transaction, use only the machine learning model 214 to process the transaction, etc.).

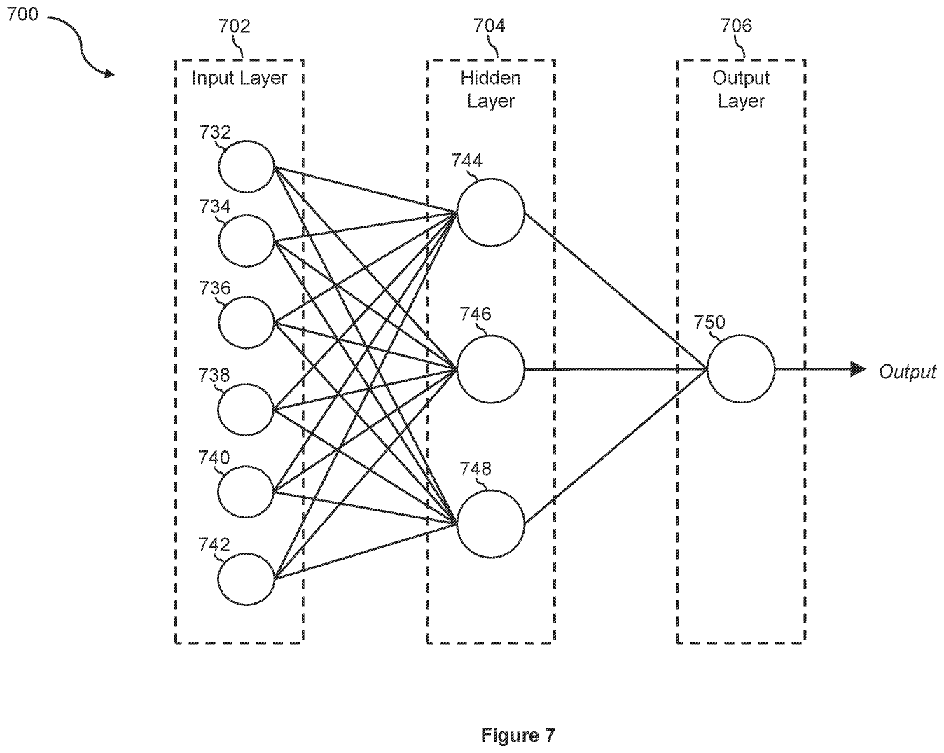

FIG. 7 illustrates an example artificial neural network 700 that may be used to implement any machine learning models (e.g., the machine learning models 212, 214, 320, 412, 414, 416, and 418, etc.). As shown, the artificial neural network 700 includes three layers-an input layer 702, a hidden layer 704, and an output layer 706. Each of the layers 702, 704, and 706 may include one or more nodes. For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. Although only one hidden layer is shown for the artificial neural network 700, it has been contemplated that the artificial neural network 700 used to implement any one of the computer-based models may include as many hidden layers as necessary.

In this example, the artificial neural network 700 receives a set of inputs and produces an output. Each node in the input layer 702 may correspond to a distinct input. For example, each node in the input layer 702 may correspond to an input feature (e.g., transaction attributes, etc.). In some embodiments, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, etc.) to each of the data values received from the nodes 732, 734, 736, 738, 740, and 742. The nodes 744, 746, and 748 may include different algorithms and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. In some embodiments, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value for the artificial neural network 700. When the artificial neural network 700 is used to implement a machine learning model configured to classify a transaction, the output value may indicate a classification for the transaction (e.g., whether the transaction is fraudulent or non-fraudulent, etc.). When the artificial neural network 700 is used to implement the efficacy determination model 320, the output value may indicate an accuracy category for the cascade machine learning model system 202 in classifying a transaction.

The artificial neural network 700 may be trained by using training data and one or more loss functions. By providing training data to the artificial neural network 700, the nodes 744, 746, and 748 in the hidden layer 704 may be trained (adjusted) based on the one or more loss functions (and also various hyperparameters) such that an optimal output is produced in the output layer 706 to minimize the loss in the loss functions. By continuously providing different sets of training data, and penalizing the artificial neural network 700 according to one or more hyperparameters when the output of the artificial neural network 700 is incorrect (as defined by the loss functions, etc.), the artificial neural network 700 (and specifically, the representations of the nodes in the hidden layer 704) may be trained (adjusted) to improve its performance in the respective tasks. Adjusting the artificial neural network 700 may include adjusting the weights associated with each node in the hidden layer 704.

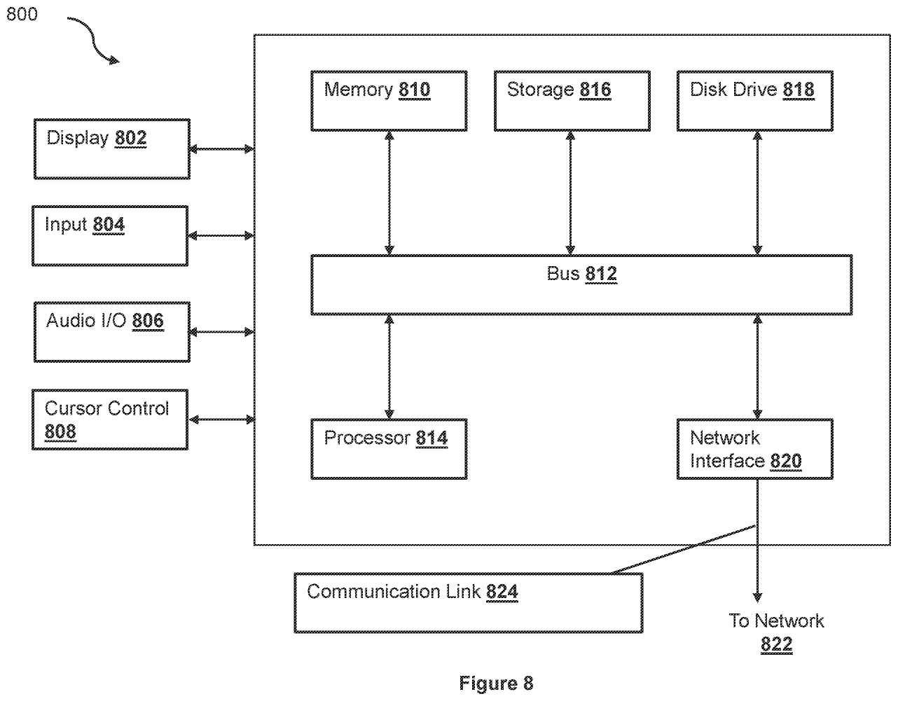

FIG. 8 is a block diagram of a computer system 800 suitable for implementing one or more embodiments of the present disclosure, including the service provider server 130, the merchant server 120, and the user device 110. In various implementations, the user device 110 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, and 130 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the cascade model system optimization functionalities described herein, for example, according to the processes 500 and 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
receiving a request for processing a transaction;
determining a set of attribute values associated with the transaction;
providing the set of attribute values to an efficacy determination model configured to evaluate an efficacy of a cascade machine learning (ML) model system for classifying the transaction;
obtaining an efficacy output from the efficacy determination model, wherein the efficacy output indicates a predicted accuracy of the cascade ML model system in classifying the transaction;
classifying, using the cascade ML model system, the transaction based on the set of attribute values when the efficacy output exceeds a threshold; and
processing the transaction based on the classifying.

2. The system of claim 1, wherein the classifying the transaction comprises:
classifying, using a first ML model in the cascade ML model system, the transaction into a first classification of a plurality of classifications.

3. The system of claim 2, wherein the classifying the transaction further comprises:
determining that the first classification corresponds to a predetermined classification; and
in response to determining that the first classification corresponds to the predetermined classification, re-classifying, using a second ML model in the cascade ML model system, the transaction into a second classification of the plurality of classifications, wherein the transaction is processed based on the second classification.

4. The system of claim 3, wherein the second classification is different from the first classification.

5. The system of claim 2, wherein the classifying the transaction further comprises:
determining that the first classification does not correspond to a predetermined classification; and
in response to determining that the first classification does not correspond to the predetermined classification, bypassing a second ML model in the cascade ML model system, wherein the transaction is processed based on the first classification.

6. The system of claim 1, wherein the cascade ML model system comprises a plurality of ML models, and wherein the operations further comprise:
determining a plurality of prediction accuracy categories based on possible prediction accuracy outcomes from different ML models in the plurality of ML models of the cascade ML model system, wherein each prediction accuracy category in the plurality of prediction accuracy categories represents a corresponding combination of prediction accuracy outcomes associated with the plurality of ML models;
determining, for a previously conducted transaction, a particular prediction accuracy category based on prediction accuracy outcomes associated with the plurality of ML models in classifying the previously conducted transaction;
labeling the previously conducted transaction with the particular prediction accuracy category;
generating training data for the efficacy determination model based at least on the previously conducted transaction labeled with the particular prediction accuracy category; and
training the efficacy determination model using the training data.

7. The system of claim 6, wherein the plurality of prediction accuracy categories comprises a first prediction accuracy category indicating an accurate prediction for each ML model in the plurality of ML models, a second prediction accuracy category indicating an accurate prediction for one of the plurality of ML models, and a third prediction accuracy category indicating an inaccurate prediction for each ML model in the plurality of ML models.

8. A method, comprising:
receiving a request for processing a transaction;
determining transaction data associated with the transaction;
determining, using an efficacy determination model configured to evaluate an efficacy of a cascade machine learning (ML) model system, an efficacy output based on the transaction data, wherein the efficacy output indicates a predicted accuracy of the cascade ML model system in classifying the transaction
modifying characteristics of the cascade ML model system for classifying the transaction based on the efficacy output, wherein the modifying the characteristics of the cascade ML model system comprises excluding one or more machine learning models within the cascade ML model system from classifying the transaction;
subsequent to the modifying the characteristics, classifying, using the cascade ML model system, the transaction based on the transaction data; and
processing the transaction based on the classifying.

9. The method of claim 8, wherein the cascade ML model system comprises a plurality of ML models, wherein the method further comprises:
configuring the plurality of ML models in the cascade ML model system as a whole.

10. The method of claim 9, wherein the configuring the plurality of ML models comprises:
determining a set of configurations for the cascade ML model system, wherein each configuration in the set of configurations represents a different set of hyperparameter values for the plurality of ML models in the cascade ML model system;
generating a plurality of instances of the cascade ML model system, wherein each instance in the plurality of instances of the cascade ML model system is configured based on a distinct configuration from the set of configurations;
testing the plurality of instances of the cascade ML model system;
selecting, from the set of configurations, a particular configuration for configuring the cascade ML model system based on the testing; and
configuring the cascade ML model system using the particular configuration.

11. The method of claim 10, wherein a particular instances of the cascade ML model system configured using the particular configuration yields a highest accuracy result among the plurality of instances based on the testing.

12. The method of claim 10, further comprising:
training the plurality of instances of the cascade ML model system using different sets of training data.

13. The method of claim 10, further comprising:
iteratively removing half of the plurality of instances of the cascade ML model system based on the testing until only one instance of the cascade ML model system remains.

14. The method of claim 18, wherein the cascade ML model system is configured to use a plurality of ML models for classifying the transaction in a cascade manner.

15. A non-transitory machine-readable medium having stored thereon machine-readable instructions executable to cause a machine to perform operations comprising:
receiving a request for processing a transaction;
determining transaction data associated with the transaction;
providing the transaction data to an efficacy determination model configured to evaluate an efficacy of a cascade machine learning (ML) model system for classifying the transaction;
obtaining an efficacy output from the efficacy determination model, wherein the efficacy output indicates a predicted accuracy of the cascade ML model system in classifying the transaction;
causing the cascade ML model system to classify the transaction based on the transaction data when the efficacy output exceeds a threshold; and
processing the transaction based on the classifying.

16. The non-transitory machine-readable medium of claim 15, wherein the operations further comprise:
in response to determining that the efficacy output exceeds the threshold, modifying characteristics of the cascade ML model system, wherein the causing the cascade ML model system to classify the transaction is further based on the modified characteristics.

17. The non-transitory machine-readable medium of claim 16, wherein the cascade ML model system comprises a plurality of ML models, and wherein the modifying the characteristics comprises excluding one or more ML models in the plurality of ML models from classifying the transaction.

18. The non-transitory machine-readable medium of claim 15, wherein the cascade ML model system comprises a plurality of ML models, wherein the operations further comprise:
configuring the plurality of ML models in the cascade ML model system as a whole.

19. The non-transitory machine-readable medium of claim 18, wherein the configuring the plurality of ML models comprises:
determining a set of configurations for the cascade ML model system, wherein each configuration in the set of configurations represents a different set of hyperparameter values for the plurality of ML models in the cascade ML model system;
generating a plurality of instances of the cascade ML model system, wherein each instance in the plurality of instances of the cascade ML model system is configured based on a distinct configuration from the set of configurations;
testing the plurality of instances of the cascade ML model system;
selecting, from the set of configurations, a particular configuration for configuring the cascade ML model system based on the testing; and
configuring the cascade ML model system using the particular configuration.

20. The non-transitory machine-readable medium of claim 19, wherein a particular instances of the cascade ML model system configured using the particular configuration yields a highest accuracy result among the plurality of instances based on the testing.
